(19) United States
(12) Patent Application Publication
(10) Pub. No.: US 2020/0159986 A1
(43) Pub. Date: May 21, 2020

(54) Text Simplification System Utilizing Eye-Tracking

(71) Applicants: Worcester Polytechnic Institute, Worcester, MA (US); University of Massachusetts, Boston, MA (US)

(72) Inventors: Soussan Djamasbi, Worcester, MA (US); Ping Chen, Boston, MA (US)

(73) Assignees: Worcester Polytechnic Institute, Worcester, MA (US); University of Massachusetts, Boston, MA (US)

(21) Appl. No.: 16/685,270

(22) Filed: Nov. 15, 2019

Related U.S. Application Data
(60) Provisional application No. 62/767,882, filed on Nov. 15, 2018.
(60) Provisional application No. 62/767,768, filed on Nov. 15, 2018.

(51) Int. Cl. G06F 40/151; G06F 40/126; G06F 3/01

(52) U.S. Cl. CPC G06F 40/151; G06F 3/017; G06F 3/013; G06F 40/126

(57) ABSTRACT

In a text simplification system, a method for replacing text in a field of view of a user, comprises receiving eye movement data from an eye-tracking device, the eye movement data relating to text provided in a field of view of a user and detecting a cognitive load associated with the eye movement and corresponding to a visual location of the field of view of the user. The method comprises, when the cognitive load meets a cognitive load threshold, identifying visualized text provided in the visual location of the field of view of the user and identifying personalization information associated with the user. The method comprises, when the personalization information meets a personalization information criterion, replacing the visualized text provided in the visual location of the field of view of the user with simplified text.

### RELATED APPLICATIONS

This patent application claims the benefit of U.S. Provisional Application No. 62/767,882 filed on Nov. 15, 2018, entitled, “Personalized Text Simplification System with Eye Tracking” and claims the benefit of U.S. Provisional Application No. 62/767,768 filed on Nov. 15, 2018, entitled, “Detecting Cognitive Load via an Eye Tracking Machine Learning System” the contents and teachings of each of which are hereby incorporated by reference in their entirety.

### BACKGROUND

The process of text simplification allows for the replacement of the lexical, grammatical, or structural complexity of text while retaining its semantic meaning. Text simplification can help various populations, including children, non-native language learners, and people with cognitive disabilities, to improve their reading comprehension.

A variety of systems are available to automate the process of text simplification. For example, a conventional lexical simplification system can simplify text by substituting infrequently-used and difficult words with frequently-used and easier words. The general process for lexical simplification includes the identification of difficult words, the identification of synonyms or similar words by various similarity measures, the ranking and selection of the best candidate word based on criteria such as language model, and the maintenance of the correct grammar and syntax of a sentence. In another example, a conventional rule-based system can utilize handcrafted rules for syntactic simplification and can substitute difficult words using a predefined vocabulary. In use, the rule-based system can analyze a syntactic structure of a sentence and, for a particular structure, can transform the sentence into a simpler structure. For example, if a long sentence contains “not only” and “but also,” a rule-based system can split the sentence into two separate sentences.

### SUMMARY

Conventional text simplification suffers from a variety of deficiencies. For example, a text alternation, including simplification may change the text phonologically, syntactically, semantically, and/or pedagogically no matter how carefully done. For example, replacing a word by its relatively simpler or easier synonym may work for some readers, yet hurt others due to cultural, regional, or even personal preferences and background.

Further, conventional text simplification systems suffer from a variety of deficiencies. For example, as provided above, conventional lexical simplification systems can substitute infrequently-used and difficult words with frequently-used and easier words. However, these text simplification systems are typically unable to simplify a complex syntactic structure. Additionally, while conventional rule-based systems can convert basic sentences into simpler structures, these types of simplification systems require a significant human-involvement to manually define the rules.

By contrast to conventional text simplification systems, embodiments of the present innovation relate to a text simplification system utilizing eye tracking. The text simplification system is configured to provide substantially real-time and personalized text simplification for a particular reader with minimal modifications to the text. As part of the personalization process, the present text simplification system can gather information about a user, generate a relevant user model, and apply the model as needed. The text simplification system can adapt its behavior to the user at the individual level and can accommodate differences among individuals. As such, the text simplification system is configured to perform accurate, real-time detection of reading difficulty occurrences and can display simplified text to a reader can in real-time, such as when a reading difficulty occurs to a specific reader on a specific piece of text. The text simplification system can include a video-based, eye-tracking component to develop a relatively accurate eye-tracking algorithm for real-time identification of text that requires higher cognitive processing.

Embodiments of the innovation relate to, in a text simplification system, a method for replacing text in a field of view of a user, comprises receiving eye movement data from an eye-tracking device, the eye movement data relating to text provided in a field of view of a user and detecting a cognitive load associated with the eye movement and corresponding to a visual location of the field of view of the user. The method comprises, when the cognitive load meets a cognitive load threshold, identifying visualized text provided in the visual location of the field of view of the user and identifying personalization information associated with the user. The method comprises when the personalization information meets a personalization information criterion, replacing the visualized text provided in the visual location of the field of view of the user with simplified text.

Embodiments of the innovation relate to a text simplification system which can include an eye-tracking device and a text simplification device disposed in electrical communication with the eye-tracking device. The text simplification device includes a controller having a memory and a processor, the controller being configured to receive eye movement data from the eye-tracking device, the eye movement data relating to text provided in a field of view of a user, detect a cognitive load associated with the eye movement and corresponding to a visual location of the field of view of the user. The controller is configured, when the cognitive load meets a cognitive load threshold to identify visualized text provided in the visual location of the field of view of the user, and identify personalization information associated with the user. The controller is configured, when the personalization information meets a personalization information criterion, to replace the visualized text provided in the visual location of the field of view of the user with simplified text.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic diagram of a text simplification system, according to one arrangement.

FIG. 2 illustrates a flowchart showing an example operation of the text simplification system of FIG. 1, according to one arrangement.

FIG. 3 illustrates a schematic diagram of an eye-tracking engine of the text simplification system of FIG. 1, according to one arrangement.

FIG. 4 illustrates a schematic diagram of the text simplification system of FIG. 1, according to one arrangement.

FIG. 5 illustrates a schematic diagram of a text simplification engine of the text simplification system of FIG. 1, according to one arrangement.

### DETAILED DESCRIPTION

Embodiments of the present innovation relate to a text simplification system utilizing eye tracking. The text simplification system is configured to provide substantially real-time and personalized text simplification for a particular reader with minimal modifications to the text. As part of the personalization process, the present text simplification system can gather information about a user, generate a relevant user model, and apply the model as needed. The text simplification system can adapt its behavior to the user at the individual level and can accommodate differences among individuals. As such, the text simplification system is configured to perform accurate, real-time detection of reading difficulty occurrences and can display simplified text to a reader can in real-time, such as when a reading difficulty occurs to a specific reader on a specific piece of text. The text simplification system can include a video-based, eye-tracking component to develop a relatively accurate eye-tracking algorithm for real-time identification of text that requires higher cognitive processing.

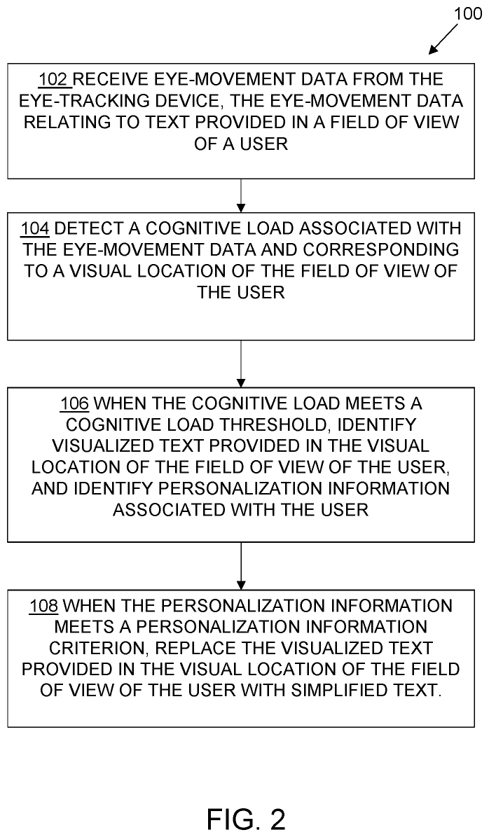

FIG. 2 illustrates a schematic representation of a text simplification system 10, according to one arrangement. As illustrated, the text simplification system 10 includes an eye-tracking device 12 disposed in electrical communication with a text simplification device 14. While each of the eye-tracking device 12 and the cognitive load detection device 14 are illustrated as standalone devices, the text simplification system 10 can include both the eye-tracking device 12 and the text simplification device 14 as part of a single device.

The eye-tracking device 12 is configured to detect the position of a user's eye relative to a field of view, such as a display 16 or any image received by the user, whether generated electronically or otherwise, based upon the measured position of the user's eye in space. In one arrangement, the eye-tracking device 12 can include an infra-red (IR) transmitter 22 and camera 24 disposed in electrical communication with a controller 25, such as a processor and a memory. For example, the eye-tracking device 12 can be a Tobii TX300 remote eye tracker (Tobii Technology AB, Sweden).

During operation, the transmitter 22 is configured to direct a light 18, such as an infrared (IR) light, against a user's eye 20. The light 18 allows the camera 24 of the eye-tracking device 12 to identify the pupil of the eye 20 and creates a glint on the surface of the eye 20. The position of the glint relative to the eye-tracking device 12 is substantially stationary. As the user's pupil and eye 20 moves to identify and track various textual items 21 within a visual location 23, the glint acts as a reference point for the camera 24. Accordingly, during operation, the eye-tracking device 12 is configured to identify the user's eye movements relative to the glint.

The text simplification device 14 is configured as a computerized device, such as a personal computer, laptop, or tablet and can include a controller 28, such as a processor and a memory. During operation, the text simplification device 14 is configured to receive eye movement data 26 from the eye-tracking device 12, to identify the text associated with visual location 23 based upon cognitive load, and to provide simplified text 90 to the user, as needed, on a user-by-user basis.

The text simplification device 14 can utilize an eye-tracking engine 40 to assess a user's cognitive load based upon the collected eye movement data 26. In one arrangement, during operation, as will be described in detail below, the eye-tracking engine 40 of the text simplification device 14 is configured to receive eye movement data 26 from the eye-tracking device 12 and to predict a user's cognitive load based upon the data 26. For example, the eye-tracking engine 40 can include a classification function 70 which is configured to predict the user's cognitive load based upon the received eye movement data 26.

In one arrangement, the text simplification device 14 can be preconfigured with a classification function 70 developed by a third-party, such as a service provider. Prior to being provided to the text simplification device 14, the third-party can train the classification function 70 with a training data set which includes collected eye movement data (e.g., saccade event, fixation event, pupil dilation event, and/or blink event data) as well as corresponding task conditions (e.g., relatively high cognitive or relatively low cognitive loading) under which the eye movement data was collected. As a result of the training, the classification function 70 can receive the eye movement data 26 without information about the associated task condition and predict a cognitive load 75 associated with the eye movement data 26.

The text simplification device 14 can utilize a text simplification engine 30 to generate a simplified text. In one arrangement, the text simplification engine 30 is configured to model text simplification as a Neural Machine Translation problem in Deep Learning. For example, the text simplification engine 30 can include a text simplification model such as an encoder-decoder model 85 having an encoder portion 86 and a decoder portion 88.

The encoder portion 86 of the encoder-decoder model 85 is configured to convert text into an encoded structure which includes the context and semantics of the text. In one arrangement, the encoder portion of the encoder-decoder model 85 can be configured as a Recurrent Neural Network (RNN). During an encoding process, the text simplification engine 30 receives text 87 which can be presented to the user, such as via the display 16. The encoder portion 86 reads each word of an input sequence (e.g., sentence) of the text 87 sequentially. The text simplification engine 30 can change a hidden state of the encoder RNN 86 as the encoder portion 86 reads each word. After reading the end of sequence, as identified by an end-of-sequence symbol, the hidden state generated by the encoder RNN 86 is a summary c of the whole input sequence, termed a context vector.

For example, given a source sentence X=(x₁, x₂, . . . , xₗ) and the target (simplified) sentence Y=(y₁, y₂, . . . , yₗ′), where xi and yᵢ are the source word and target word respectively, l and l′ are the length of each sentence. The text simplification engine 30 can be configured to model the conditional probability p(Y|X) and then be trained to maximize the probability to generate the encoder portion 86 of the encoder-decoder model 85. The text simplification engine 30 can use one-hot representation of words in the sequence in the input layer, each word xᵢ in the sentence being represented as an R|V|×1 vector with all Os and one 1 at the index of that word in vocabulary V. The text simplification engine 30 can then convert the one hot representation wᵢ to a D-dimensional vector eᵢ in the following embedding layer by looking up the word embedding from the word embedding matrix E, where E is an element of R^{n×|V|}. The embedding layer converts the “bag of words” sparse features to dense features as provided by the relationship eᵢ=Exᵢ. The learned word embedding can capture semantic meaning of the word.

Next, the text simplification engine 30 can input the word embedding to the encoder layer sequentially. For example, the encoder portion or layer 86 (function ƒ) can be configured as a single layer Long Short Term Memory networks (LSTM) or bidirectional LSTM. After the text simplification engine 30 feed the word embeddings, the encoder layer produces a sequence of encoder hidden states hᵢ, as provided by the relationship hᵢ=ƒ(xᵢ, hᵢ₋₁) which ignores the embedding eᵢ and utilizes xᵢ as the input.

The decoder portion 88 of the encoder-decoder model 85 is configured to decode the encoded structure and semantics provided by the encoder portion 86 to generate simplified text 90. In one arrangement, the decoder portion 88 of the encoder-decoder model 85 can also be configured as an RNN which can be trained to generate an output sequence by predicting next word given the current hidden state and context vector c. Alternately, the decoder portion 88 can be configured to initialize the hidden state as context vector c, and then generate the output sequence by predicting next word given current hidden state.

It is noted that the text simplification device 14 can utilize the text simplification engine 30 to generate the simplified text in advance of the utilization of the eye-tracking engine 40 to determine cognitive load. However, the determination of which simplified piece of text to be provided as simplified text 90 to the display 16 can be performed in real-time in response to the eye-tracking engine 40 detecting the presence of a cognitive load. As such, the text simplification device 14 can provide personalized text simplification when a reading difficulty occurs to a specific reader on a specific piece of text.

The text simplification device 14 is also configured to receive personalization information 82 from the user. As provided above, the text simplification device 14 can provide simplified text 90 to the display 16 to replace a specific piece of text for a specific reader. Accordingly, the text simplification device 14 can output the simplified text 90 on a case-by-case basis based upon the personalization information 82. For example, at start up, the text simplification device 14 can provide the user with a graphical user interface requesting that the user input certain pieces of information. This can include information pertaining to the user's nationality, native language, and age, for example. The text simplification device 14 can utilize this personalization information 82 to determine if simplified text 90 should be provided to the user in the presence of a relatively high cognitive load 75.

The controller 28 of the text simplification device 14 can store an application for cognitive load detection and text simplification. The detection and simplification application installs on the controller 28 from a computer program product 95. In some arrangements, the computer program product 95 is available in a standard off-the-shelf form such as a shrink wrap package (e.g., CD-ROMs, diskettes, tapes, etc.). In other arrangements, the computer program product 95 is available in a different form, such downloadable online media. When performed on the controller 28 of the text simplification device 14, the detection and simplification application causes the text simplification device 14 to predict the cognitive load of a user and to selectively provide simplified text 90 to the user.

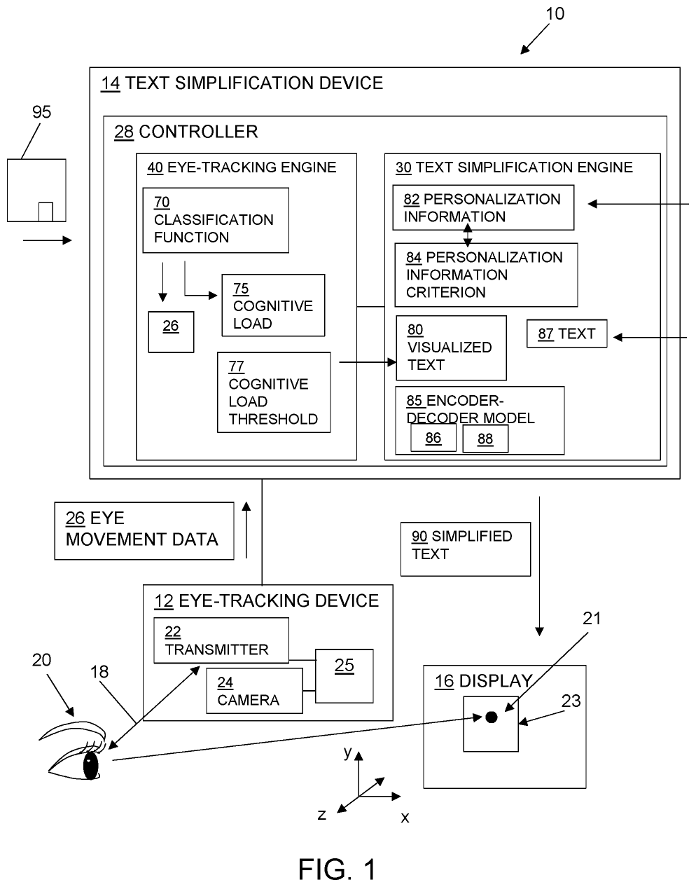

FIG. 2 illustrates a flow chart 100 of a procedure performed by the text simplification device 14 of the text simplification system 10 of FIG. 1 when detecting cognitive load and replacing text in a field of view of a user.

In element 102, the text simplification device 14 is configured to receive eye movement data 26 from the eye-tracking device 12, the eye movement data 26 relating to text 21 provided in a field of view 16 of a user.

For example, with reference to FIG. 1, as a user visually focuses on a field of view, such as the display 16, the controller 25 of the eye-tracking device 12 can detect the eye position of the user's pupil in three dimensions (x, y, z) when viewing text 21 within a particular visual location 23 in the field of view 16, and can project the user's eye position into two dimensions (x, y in another coordinate system). The two-dimensional coordinate represents where the user is looking in the field of view 16. Based upon the detected positioning of the pupil relative to the glint, the eye-tracking device 12 collects a vertical and lateral coordinate (x, y) of the user's visual focus on the visual location 23 of the display 16, termed a gaze position data element.

For each gaze position data element collected, the controller 25 can also collect an associated time measurement (t). For example, the eye-tracking device 12 can be configured to collect gaze position data elements at a rate between about 10 Hz and 1250 Hz. Assuming the case where the eye-tracking device 12 collects data at a rate of 30 Hz, for each gaze position data element collected, the eye-tracking device 12 associates a corresponding time of 1/30 second.

Based upon the gaze position data elements collected, the controller 25 of the eye-tracking device 12 can identify the position of the user's eyes relative to the text 21 within the visual location 23, such as a portion of a website, provided by the display 16, and can provide the position as part of the eye movement data 26 as coordinate information 206. Further, the controller 25 of the eye-tracking device 12 can identify the type of eye movement associated with the gaze position data elements. For example, the eye-tracking device 12 can identify the gaze position data elements as fixation event data or as saccade event data. Fixation event data can identify fixations or pauses over informative regions of interest, along with the associated vertical and lateral coordinates (x, y). By contrast, saccade event data can identify relatively rapid movements, or saccades, between fixations used to recenter the eye on a new location, along with the vertical and lateral coordinate (x, y).

The controller 25 of the eye-tracking device 12 can also be configured to collect pupil dilation event data when collecting gaze position data elements. In one arrangement, when collecting gaze position data elements, the controller 25 can also detect, as the pupil dilation event data, the size or diameter of the user's pupil. In another arrangement, the controller 25 can detect, as the pupil dilation event data, pupil dilation variance data. For example, the controller 25 can calculate pupil dilation variance, or rate of change of a user's pupil dilation, by taking the temporal derivative of the user's pupil dilation at the time of collection of either the fixation event data or saccade event data.

The controller 25 of the eye-tracking device 12 can also be configured to collect blink event data when collecting gaze position data elements. Blink event data, or blinks, relate to the involuntary act of shutting and opening the eyelids and can reflect changes in a user's attention. For example, a fewer number of blinks over a time period have been associated with increased user attention. In another example, the duration of a user's blinks can also indicate cognitive effort such that shorter blink durations have been associated with increased visual workload. Accordingly, blink event data can reflect a user's cognitive load.

The eye-tracking device 12 can provide the saccade event data, fixation event data, pupil dilation event data, and blink event data, either alone or in combination, as well as coordinate information relating to the visual location 23, as eye movement data 26 to the text simplification device 14 for further processing.

Returning to FIG. 2, in element 104, the text simplification device 14 is configured to detect a cognitive load 75 associated with the eye movement data 26 and corresponding to a visual location 23 of the field of view 16 of the user. In one arrangement, the eye tracking engine 40 of the text simplification device 14 can be configured to determine the user's cognitive load 75 in a variety of ways. For example, with reference to FIG. 1, when detecting a cognitive load 75 of the user, the eye-tracking engine 40 can be configured to apply the classification function 70 to the eye movement data 26 to detect the cognitive load 75 associated with the eye movement data 26 and corresponding to the visual location 23 of the field of view 16 of the user.

As provided above, the classification function 70 can be developed to predict the cognitive load 75 associated with the eye movement data 26 based on a training data set. As such, when executing the classification function 70 relative to the eye movement data 26, the eye-tracking engine 40 can be configured to predict the user's cognitive load 75 based upon a saccade event, fixation event, pupil dilation event, or blink event data, either alone or in combination. For example, the eye-tracking engine 40 can apply the classification function 70 to a pupil dilation event associated with a saccade event, as provided by the eye movement data 26, to identify the cognitive load 75 of the user. In another example, the eye-tracking engine 40 can apply the classification function 70 to a pupil dilation event associated with a fixation event, as provided by the eye movement data 26, to identify the cognitive load 75 of the user.

Returning to FIG. 2, in element 106, when the cognitive load 75 meets a cognitive load threshold 77, the text simplification device 14 is configured to identify visualized text 80 provided in the visual location 23 of the field of view 16 of the user and to identify personalization information 82 associated with the user.

For example, with reference to FIG. 1, when the eye-tracking engine 40 identifies the cognitive load 75 associated with the user's eye movements, the eye-tracking engine 40 can compare the cognitive load 75 against a relative standard or threshold 77 to determine whether the cognitive load 75 can be considered as being relatively low or high. In the case where the eye-tracking engine 40 determines that the cognitive load 75 meets a cognitive load threshold 77 (e.g., is relatively high thereby indicating that the text 21 in the field of view is an object of focused attention), the eye-tracking engine 40 is further configured to identify the text contained within the visual location 23 which is the source of the cognitive load 75.

As provided above, the eye-tracking engine 40 can receive eye movement data 26 having coordinate information relating to a given visual location 23 from the eye-tracking device 12. Accordingly, when the eye-tracking engine 40 detects the presence of a cognitive load 75, the eye-tracking engine 40 can have the coordinate location of the text, but not the text itself. As such the eye-tracking engine 40 can identify the text within the visual location 23, as identified by the coordinate information in a variety of ways.

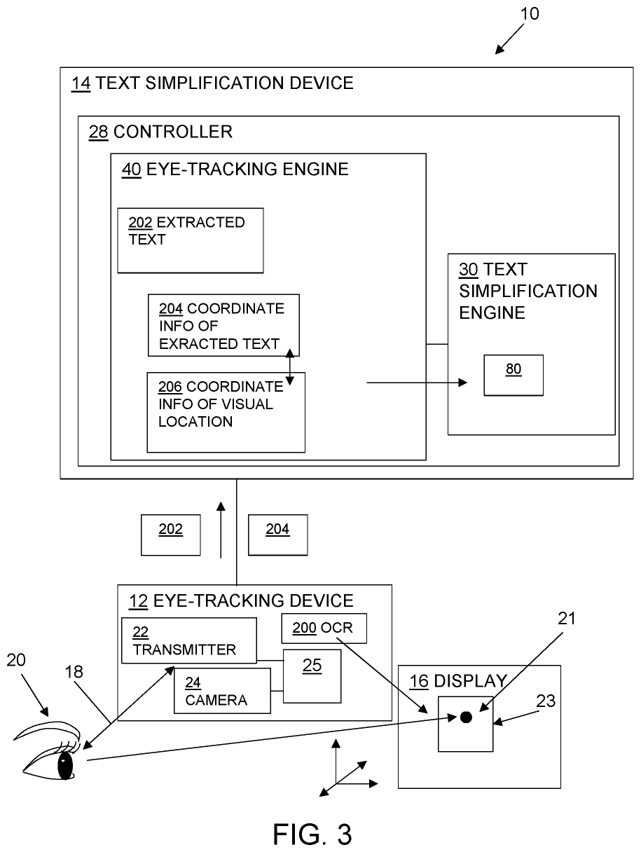

In one arrangement, with reference to FIG. 3, the eye-tracking engine 40 can receive extracted text 202 and text coordinate information 204 from an optical character recognition (OCR) device 200. For example, the OCR device 200 can be disposed in optical communication with the visual location 23 of the user and in electrical communication with the text simplification device 14. As illustrated, the OCR device 200 can be integrally formed with the eye-tracking device 12 or may be configured as a stand-alone device electrically coupled to the text simplification device 14.

During operation, the OCR device 200 can retrieve the image provided within the field of view of the user, such as the display 16, and can utilize conventional OCR technology to extract text (e.g., word, phrase, sentence, and paragraph) from that image. For example, in the case where the display 16 provides a webpage, the OCR device 200 can take an image or the webpage and can extract all of the text provided on the webpage. The OCR device 200 can provide the resulting extracted text 202 to the eye-tracking engine 40. Further, for each text item extracted from the image, the OCR device 200 can associate a corresponding set of vertical and lateral coordinates (x, y) of the field of view 16 to each extracted text item and can provide the resulting coordinate information 204 to the eye-tracking engine 40.

Once the eye-tracking engine 40 has received the extracted text 202 and associated coordinate information 204, the eye-tracking engine 40 can compare the coordinate information 206 of the visual location 23 of the field of view 16 of the user with the coordinate information 204 of each text element contained within the extracted text 202. As indicated above, the coordinate information 206 can be provided to the eye-tracking engine 40 by the eye-tracking device 12 as provided as part of the eye movement data 26 and can identify the location of the detected cognitive load 75. In the case where the coordinate information 206 of the visual location 23 meets the coordinate information 204 of the extracted text 202, the eye-tracking engine 40 can identify the associated extracted text 202 as visualized text 80 (e.g., as word, phrase, sentence, or paragraph text 21 identified within the visual location 23).

Returning to FIG. 2, in element 108, when the personalization information 82 meets a personalization information criterion 84 the text simplification device 14 is configured to replace the visualized text 80 provided in the visual location 23 of the field of view 16 of the user with simplified text 90. In certain cases, the user may not want to have the text 21 replaced with simplified text 90, as this can cause the user some amount of irritation, particularly for multiple instances of reading difficulty or increased cognitive load. Accordingly, the text simplification device 14 can be configured to personalize the delivery of the simplified text 90 and to minimize the cases where it replaces the text 21 with simplified text 90 based upon the personalization information 82 and personalization information criterion 84.

For example, with reference to FIG. 1 and as provided above, at start up, the text simplification device 14 can receive personalization information 82 from the user which can pertain to the user's nationality, native language, and age. The text simplification device 14 can utilize the personalization information 82 and personalization information criterion 84 to determine if simplified text 90 should be provided to the user in the presence of a relatively high cognitive load 75. During operation, the text simplification engine 30 can compare the personalization information 82 with the personalization information criterion 84 which can further instruct the text simplification engine 30 how to proceed with delivery of simplified text 90 to the display 16.

For example, the personalization information criterion 84 can indicate that the text simplification engine 30 withhold delivery of the simplified text 90 to the display 16 if the user's native language is English but to deliver the simplified text 90 to the display 16 if the user's native language is non-English. In the case where the user's personalization information 82 identifies the user as having a non-English native language, the text simplification engine 30 can transmit the simplified text 90 to the display 16 to replace the visualized text 80 provided in the visual location 23. It is noted that the simplified text 90 can replace a word, phrase, sentence, or paragraph, as identified within the visual location 23. Further, the text simplification device 14 can provide the simplified text 90 to the display 16 in substantially real-time relative to the development of the user's focused attention on a given portion of text 21.

In one arrangement, the text simplification device 14 can also be configured to provide personalized feedback to the user relative to the text 21 which is causing cognitive loading of to the user. The personalized feedback can allow the user to gain a better understanding of the subject matter associated with the text 21. For example, the personalized feedback can ask the user if he would like additional information, such as a video, about the topic associated with the text 21 causing the focused attention.

Accordingly, the text simplification device 14 is configured to provide substantially real-time and personalized text simplification for a particular reader with minimal modifications to the text. As such, the text simplification device 14 mitigates changes to the text which can cause phonologic, syntactic, semantic, and/or pedagogical alterations. Further, the use of the eye-tracking engine 40 and the text simplification engine 30 can mitigate the need for human involvement, as needed in conventional rule-based systems.

As provided above, the text simplification device 14 can transmit simplified text 90 to the display 16 to replace the text 21 provided in the visual location 23. In one arrangement, the text simplification device 14 can repeat the process to further simplify the displayed simplified text 90 if the user continues to encounter difficulty in reading.

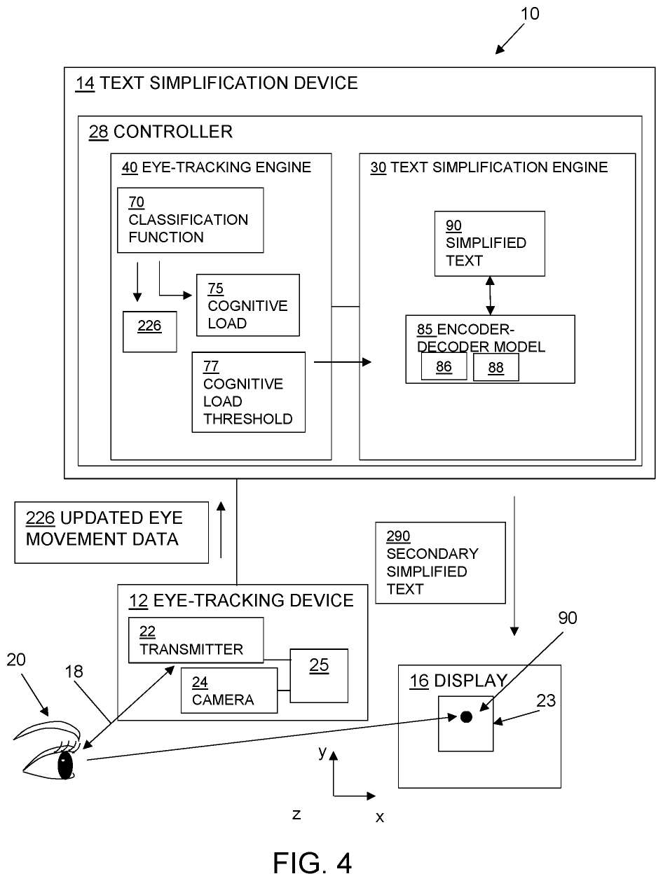

For example, with reference to FIG. 4, during operation the eye-tracking engine 40 of the text simplification device 14 can receive updated eye movement data 226 from the eye-tracking device 12, the updated eye movement data 226 relating to the simplified text 90 provided in the field of view 16 of the user. Based upon the updated eye movement data 226, the eye-tracking engine 40 can detect a cognitive load 75 associated with the eye movement data 226 and corresponding to the simplified text 90 provided in the field of view 16 of the user. IN one arrangement, the eye-tracking engine 40 can be configured to apply the classification function 70 to the updated eye movement data 226 to detect the cognitive load 75 associated with the eye movement data 26 and corresponding to the simplified text 90. For example, when executing the classification function 70 relative to the eye movement data 26, the eye-tracking engine 40 can be configured to predict the user's cognitive load 75 based upon a saccade event, fixation event, pupil dilation event, or blink event data, either alone or in combination, as identified by the updated eye movement data 226.

When the cognitive load 75 meets a cognitive load threshold 77, the text simplification device 14 can apply a text simplification model to the simplified text 90 to generate secondary simplified text 290. For example, when the eye-tracking engine 40 determines that the cognitive load 75 meets a cognitive load threshold 77 (e.g., is relatively high thereby indicating that the text 21 in the field of view is an object of focused attention), the eye-tracking engine 40 can direct the text simplification engine 30 to execute the text simplification model, such as the encoder-decoder model 85, relative to the simplified text 90 to create the secondary simplified text 290. Once generated, the text simplification device 14 can forward the secondary simplified text 290 to the display 16 and can replace the corresponding simplified text as initially provided in the visual location 23 of the display 16.

As described above, text simplification device 14 can apply the encoder-decoder model 85 to text 87 which can mirror the text 21 provided by the display 16 to the user. The model 85 can simplify the words and/or phrases found in the text document 87 which can later be used to generate simplified text 90 in cases where a user has difficulty in reading the text 21 provided by the display 16. Such description is by way of example only. In one arrangement, the text simplification device 14 is configured to utilize embedded features associated with the text 87 to expedite the text simplification process.

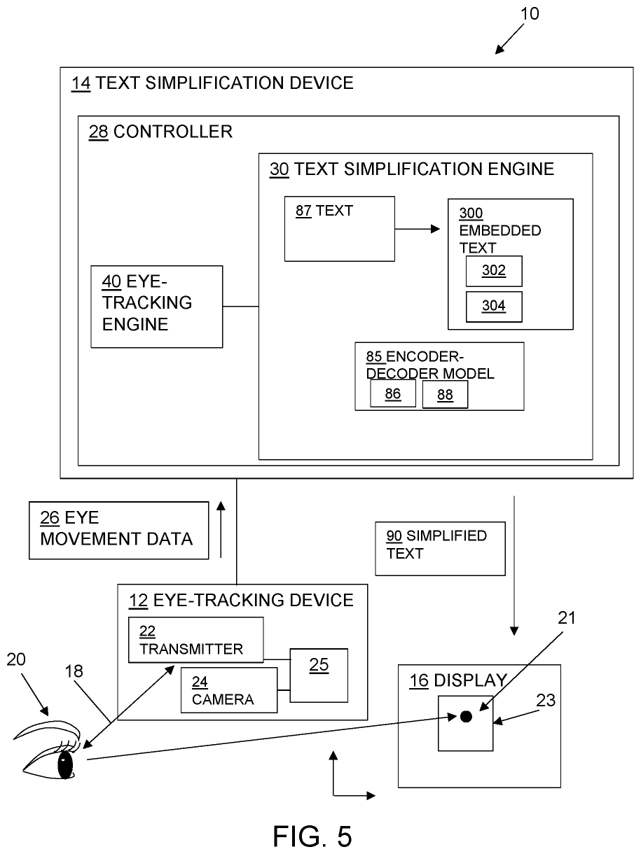

During operation, with reference to FIG. 5, the text simplification engine 30 of the text simplification device 14 can receive a text file 87 corresponding to the text provided by the display 16. Following receipt, the text simplification engine 30 can generate embedded feature text 300 based upon the text file 87 where the embedded feature text 300 includes text elements having at least one associated embedded feature. The embedded feature can identify a particular part of speech associated with a word and can provide linguistic structure information.

In one arrangement, the text simplification engine 30 can provide an embedded feature 302 to words within the text file 87 having a syllable count that meets a syllable count threshold. For example, words with a relatively large number of syllables are more likely to be difficult. Accordingly, for a syllable count threshold of four syllables, the text simplification engine 30 can tag words within the text file 87 having more than four syllables with the embedded feature 302. In one arrangement, the text simplification engine 30 can provide an embedded feature 304 to words within the text file 87 which occur in the text file at a frequency which is lower than a given word occurrence count threshold. For example, words having a relatively low frequency within the text file 87 are likely to be difficult words. Accordingly, for a word occurrence count of less than 1000, which indicates the presence of relatively rare words in the text file 87, the text simplification engine 30 can tag words within the text file 87 having fewer than 1000 occurrences with the embedded feature 304.

Following generation of the embedded feature text 300, the text simplification engine 30 can apply a text simplification model, such as the encoder-decoder model 85, to the embedded feature text 300 to generate simplified text 90 corresponding to at least one embedded feature 302, 304 of the embedded feature text 300. For example, following detection of a cognitive load 75 meeting a cognitive load threshold 77, the text simplification engine 30 can execute the encoder-decoder model 85 relative to the embedded feature text 300 to simplify only text elements that include an associated embedded feature 302, 304. As such, execution of the text simplification process can mitigate a load on the text simplification engine 30.

While various embodiments of the innovation have been particularly shown and described, it will be understood by those skilled in the art that various changes in form and details may be made therein without departing from the spirit and scope of the innovation as defined by the appended claims.

What is claimed is:

1. A text simplification system, comprising:
an eye-tracking device; and
a text simplification device disposed in electrical communication with the eye-tracking device, the text simplification device comprising a controller having a memory and a processor, the controller configured to:
receive eye movement data from the eye-tracking device, the eye movement data relating to text provided in a field of view of a user,
detect a cognitive load associated with the eye movement data and corresponding to a visual location of the field of view of the user,
when the cognitive load meets a cognitive load threshold:
identify visualized text provided in the visual location of the field of view of the user, and
identify personalization information associated with the user, and
when the personalization information meets a personalization information criterion, replace the visualized text provided in the visual location of the field of view of the user with simplified text.

2. The text simplification system of claim 1, wherein when receiving the eye movement data from the eye-tracking device, the controller is configured to receive at least one of saccade event data, fixation event data, pupil dilation event data, and blink event data.

3. The text simplification system of claim 1, wherein when detecting the cognitive load of the associated with the eye movement data, the controller is configured to apply a classification function to the eye movement data to detect the cognitive load associated with the eye movement data and corresponding to the visual location of the field of view of the user.

4. The text simplification system of claim 1, wherein when identifying visualized text provided in the visual location of the field of view of the user the controller is configured to:
receive extracted text from the text provided in the field of view of the user and coordinate information associated with each element of the extracted text;
compare the coordinate information of the visual location of the field of view of the user associated with the cognitive load with the coordinate information of the extracted text; and
when the coordinate information of the visual location meets the coordinate information of the extracted text, detect the extracted text associated with the coordinate information of the extracted text as the visualized text.

5. The text simplification system of claim 4, further comprising an optical character recognition device disposed in optical communication with the field of view of the user and in electrical communication with the text simplification device, the optical character recognition device configured to extract text from the text provided in the field of view of the user and coordinate information associated with the text provided in the field of view of the user.

6. The text simplification system of claim 1, wherein the controller is further configured to:
receive a text file corresponding to the text provided in the field of view of a user;
generate embedded feature text based upon the text file, the embedded feature text having at least one associated embedded feature; and
apply a text simplification model to the embedded feature text to generate simplified text corresponding to the at least one embedded feature of the embedded feature text.

7. The text simplification system of claim 6, wherein the at least one associated embedded feature comprises a syllable count that meets a syllable count threshold.

8. The text simplification system of claim 6, wherein the at least one associated embedded feature comprises a word occurrence count below a word occurrence count threshold.

9. The text simplification system of claim 6, wherein when applying the text simplification model to the embedded feature text, the controller is configured to apply an encoder-decoder model to the embedded feature text to generate simplified text corresponding to the at least one embedded feature of the embedded feature text.

10. The text simplification system of claim 1, wherein the controller is further configured to:
receive eye movement data from the eye-tracking device, the eye movement data relating to the simplified text provided in the field of view of the user;
detect a cognitive load associated with the eye movement data and corresponding to the simplified text provided in the field of view of the user;
when the cognitive load meets a cognitive load threshold, apply a text simplification model to the simplified text to generate secondary simplified text corresponding to the simplified text; and
replace the simplified text provided in the visual location of the field of view of the user with the secondary simplified text.

11. In a text simplification system, a method for replacing text in a field of view of a user, comprising:
receiving eye movement data from an eye-tracking device, the eye movement data relating to text provided in a field of view of a user;
detecting a cognitive load associated with the eye movement data and corresponding to a visual location of the field of view of the user;
when the cognitive load meets a cognitive load threshold:
identifying visualized text provided in the visual location of the field of view of the user, and
identifying personalization information associated with the user; and
when the personalization information meets a personalization information criterion, replacing the visualized text provided in the visual location of the field of view of the user with simplified text.

12. The method of claim 11, wherein receiving the eye movement data from the eye-tracking device comprises receiving at least one of saccade event data, fixation event data, pupil dilation event data, and blink event data.

13. The method of claim 11, wherein detecting the cognitive load associated with the eye movement data comprises applying a classification function to the eye movement data to detect the cognitive load associated with the eye movement data and corresponding to the visual location of the field of view of the user.

14. The method of claim 11, wherein identifying visualized text provided in the visual location of the field of view of the user comprises:
receiving extracted text from the text provided in the field of view of the user and coordinate information associated with each element of the extracted text;
comparing the coordinate information of the visual location of the field of view of the user associated with the cognitive load with the coordinate information of the extracted text; and
when the coordinate information of the visual location meets the coordinate information of the extracted text, detecting the extracted text associated with the coordinate information of the extracted text as the visualized text.

15. The method of claim 14, further comprising extracting text from the text provided in the field of view of the user and coordinate information associated with the text provided in the field of view by an optical character recognition device disposed in optical communication with the field of view of the user and in electrical communication with the text simplification device.

16. The method of claim 1, further comprising:
receiving a text file corresponding to the text provided in the field of view of a user;
generating embedded feature text based upon the text file, the embedded feature text having at least one associated embedded feature; and
applying a text simplification model to the embedded feature text to generate simplified text corresponding to the at least one embedded feature of the embedded feature text.

17. The method of claim 16, wherein the at least one associated embedded feature comprises a syllable count that meets a syllable count threshold.

18. The method of claim 16, wherein the at least one associated embedded feature comprises a word occurrence count below a word occurrence count threshold.

19. The method of claim 16, wherein applying the text simplification model to the embedded feature text comprising applying an encoder-decoder model to the embedded feature text to generate simplified text corresponding to the at least one embedded feature of the embedded feature text.

20. The method of claim 11, further comprising:
receiving eye movement data from the eye-tracking device, the eye movement data relating to the simplified text provided in the field of view of the user;
detecting a cognitive load associated with the eye movement data and corresponding to the simplified text provided in the field of view of the user;
when the cognitive load meets a cognitive load threshold, applying a text simplification model to the simplified text to generate secondary simplified text corresponding to the simplified text; and
replacing the simplified text provided in the visual location of the field of view of the user with the secondary simplified text.
